(19) United States
(12) Patent Application Publication
(10) Pub. No.: US 2014/0151209 A1
(43) Pub. Date: Jun. 5, 2014

(54) THIN KEYBOARD

(71) Applicant: ZIPPY TECHNOLOGY CORP., New Taipei City (TW)

(72) Inventor: Chin-Wen CHOU, New Taipei City (TW)

(73) Assignee: ZIPPY TECHNOLOGY CORP., New Taipei City (TW)

(21) Appl. No.: 13/692,776

(22) Filed: Dec. 3, 2012

(51) Int. Cl. H01H 13/705

(52) U.S. Cl. CPC H01H 13/705
USPC 200/5 A

(57) ABSTRACT

A thin keyboard includes a circuit board, a plurality of keycaps and a frame. The circuit board has a plurality of command portions to receive contact to generate command signals and a plurality of elastic support members located on the command portions. Each keycap is corresponding to one elastic support member and has at least one depressible press surface and a holding surface formed at an elevation difference interval with the press surface. The transverse cross section of the holding surface is greater than the transverse cross section of the press surface. The frame is positioned corresponding to the keycaps and has a plurality of installation portions corresponding to the keycaps, and a plurality of ribs abutting the circumference of the installation portions and overlapped over the holding surface of each keycap. Each installation portion has a carved out area which is smaller than the holding surface.

### FIELD OF THE INVENTION

The present invention relates to a keyboard and particularly to a thin keyboard without driven mechanisms.

### BACKGROUND OF THE INVENTION

There are many types of conventional computer input devices, such as optical disk drives, mouse, keyboards and the like. Take keyboards for instance, a conventional keyboard, such as one disclosed in R.O.C. patent Nos. 445471, I220213 and M346861, generally includes a plurality of keycaps, a circuit board triggered by the keycaps to generate command signals, a baseboard located at one side of the circuit board, and a plurality of driven mechanisms to bridge respectively each keycap and the baseboard. The keycaps are depressible to move towards the circuit board, and the driven mechanisms are driven at the same time towards the circuit board to set on a circuit switch located thereon to generate a corresponding command signal. The driven mechanism generates deformation during movement of the keycap. The driven mechanism is formed at a certain thickness which becomes a constraint that creates difficulty in design of thinner keyboards. However, thin and lightweight has become a prevailing trend in computer design nowadays. Take a notebook computer for instance, its total thickness is determined by the thickness of the keyboard. Hence almost all computer makers have devoted a lot of efforts and investments trying to make the keyboard thinner and lighter in weight.

Some producers have focused on structural design improvement of the driven mechanism. For instance, R.O.C. patents M434979, M419973 and M426075 have either proposed a novel structure for the driven mechanism or another element to substitute the driven mechanism. But their structures still have a substantial thickness which becomes a constraint in the design of thinner keyboards.

### SUMMARY OF THE INVENTION

The primary object of the present invention is to provide a frame to confine positioning and movement of keycaps to facilitate making of thinner keyboards.

To achieve the foregoing object the present invention provides a thin keyboard which includes a circuit board, a plurality of keycaps and a frame. The circuit board has a plurality of command portions to receive contact to generate command signals and a plurality of elastic support members located on the individual command portions. Each keycap is corresponding to one elastic support member and has at least one depressible press surface and a holding surface opposed the press surface and formed at an elevation difference interval with the press surface. The transverse cross section of the holding surface is greater than the transverse cross section of the press surface. The frame is positioned corresponding to the keycaps and has a plurality of installation portions which have carved out zones corresponding to the keycaps and formed at a size smaller than the holding surface, and a plurality of ribs abutting the circumference of the installation portions and overlapped over the holding surface of each keycap. The installation portions and ribs confine positioning and movement of the keycaps.

In one embodiment the frame is formed at a thickness smaller or equal to the elevation difference interval of the press surface and holding surface.

In another embodiment the holding surface is extended beyond two sides of the press surface.

In yet another embodiment the ribs are overlapped over two end portions of the press surface.

In yet another embodiment the frame includes a retaining portion corresponding to the holding surface at a location where the rib overlaps over the holding surface.

In yet another embodiment the elastic support member is located in the center or four corners of each keycap.

In yet another embodiment the elastic support member has a trigger portion depressible by the keycap to connect the circuit board to generate a command signal. The elastic support member can be a flexible dome.

In yet another embodiment each keycap has a bottom surface on another side opposite to the press surface and holding surface and facing the circuit board. The bottom surface has a contact portion extended towards the circuit board.

Through the aforesaid structure, compared with the conventional keyboards, the invention provides many advantages, notably:

1. Total keyboard thickness can be reduced. The thin keyboard of the invention confines positioning and movement of the keycaps through the frame, provides a return action force to the depressed keycap through the elastic support member, and does not have the conventional driven mechanism, hence can be made thinner.

2. Assembly of the keyboard is simpler. Through simplified positioning the thin keyboard of the invention can be assembled and installed. Compared with the conventional keyboard that requires repeatedly latching and coupling processes to finish assembly of various elements and driven mechanisms, the invention provides a simpler assembly and installation approach.

3. Simplified keyboard structure. Compared with the conventional keyboard relied on a baseboard to hold driven mechanisms that requires a lot of related keyboard assembly structures, the thinner keyboard of the invention does not have driven mechanisms, hence the baseboard can also be omitted. As a result, the structure of the thin keyboard can be simplified.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the thin keyboard of the invention.

FIG. 2 is a top view of the first embodiment of the thin keyboard of the invention.

FIG. 3 is a cross section taken on line A-A in FIG. 2.

FIG. 4 is a top view of a second embodiment of the thin keyboard of the invention.

FIG. 5 is an exploded view of a third embodiment of the thin keyboard of the invention.

FIG. 6 is a cross section of a fourth embodiment of the thin keyboard of the invention.

FIG. 7 is an exploded view of a fifth embodiment of the thin keyboard of the invention.

### DETAILED DESCRIPTION OF THE PREFERRED EMBODIMENTS

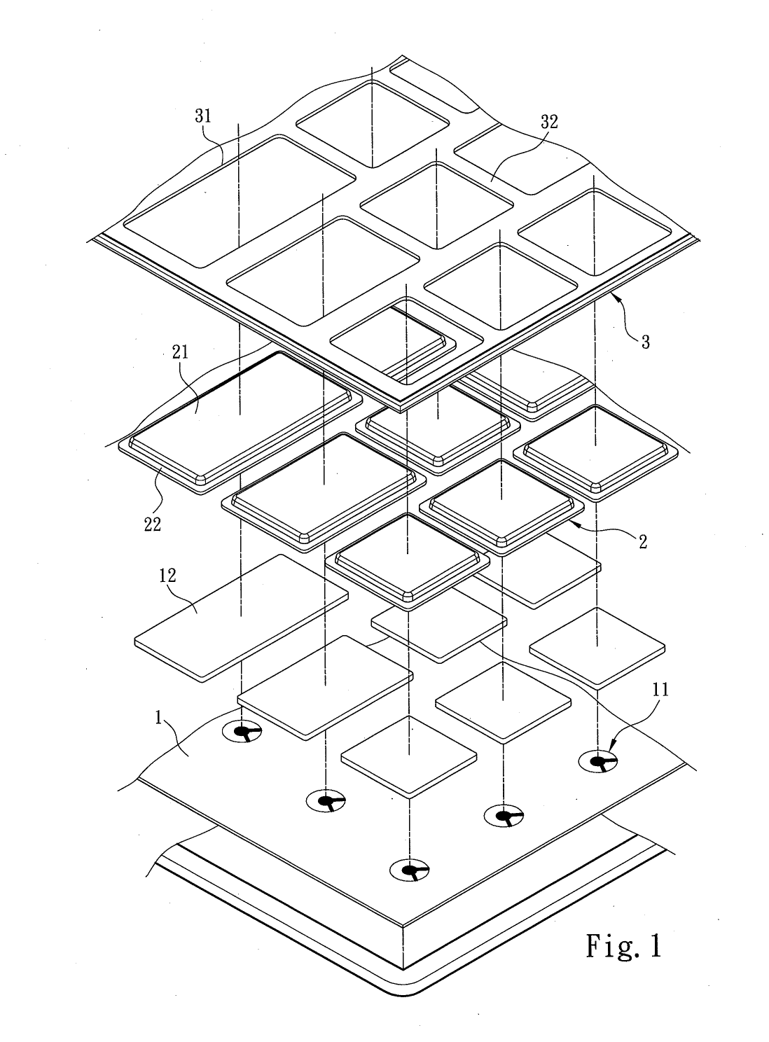

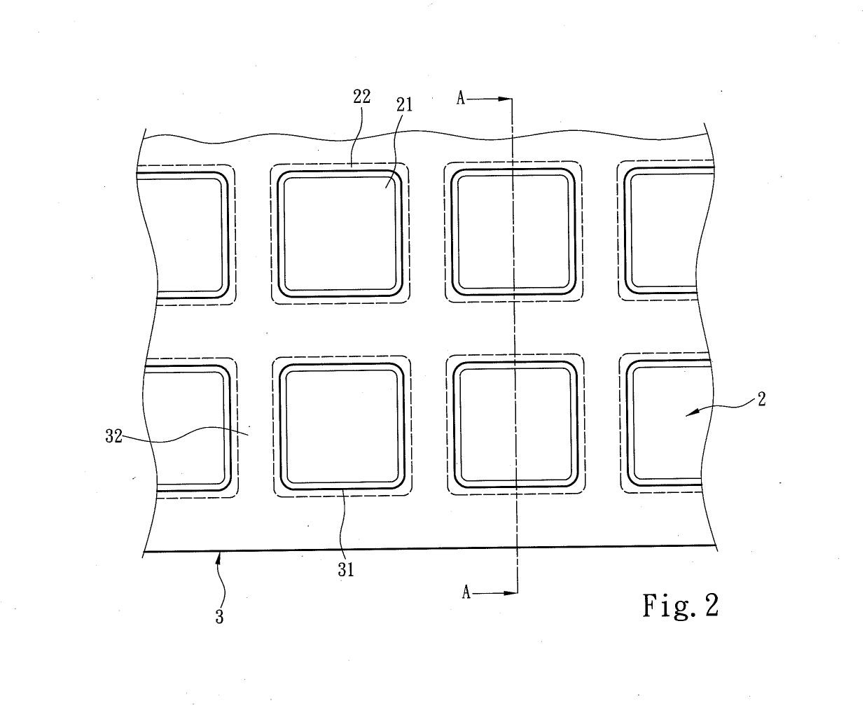

Please referring to FIGS. 1, 2 and 3, the present invention aims to provide a thin keyboard which includes at least one circuit board 1, a plurality of keycaps 2 located on the circuit board 1 and a frame 3 corresponding to the keycaps 2. More specifically, the circuit board 1 has a plurality of command portions 11 to generate command signals by contact and a plurality of elastic support members 12 located on the command portions 11. Each keycap 2 is positioned to mate one elastic support member 12. Each keycap 2 also has at least one depressible press surface 21 and a holding surface 22 opposed the press surface 21 and formed at an elevation difference interval H with the press surface 21. The holding surface 22 has a transverse cross section greater than the press surface 21. The frame 3 has a plurality of installation portions 31 corresponding to the keycaps 2 and a plurality of ribs 32 abutting the circumference of the installation portions 31. The installation portions 31 have carved out zones formed at a size smaller than the holding surface 22, i.e. smaller than the transverse cross section of the holding surface 22.

For assembly of the thin keyboard of the invention, first, place the elastic support members 12 on the circuit board 1 corresponding to the command portions 11; next, place the keycaps 2 individually onto each elastic support member 12; finally, mount the frame 3 with the installation portions 31 corresponding to the keycaps 2, with each rib 32 overlapped over the holding surface 22 of each keycap 2. Thereby the installation portions 31 and ribs 32 can confine positioning and movement of the keycap 2. The frame 3 can be formed at a thickness smaller than the elevation difference interval H of the press surface 21 and holding surface 22, namely, when the installation is finished, the press surface 21 of the keycap 2 is extended outside the frame 3, hence when the keycap 2 is depressed towards the circuit board 1, it is confined in the installation portion 31, thereby the keycap 2 does not escape the installation portion 31 when depressed. The thickness of the frame 3 can also be same as the elevation difference interval H of the press surface 21 and holding surface 22. The frame 3 further includes a retaining portion 33 corresponding to the holding surface 22 and overlapped thereof. The retaining portion 33 can further confine the keycap 2 on the frame 3.

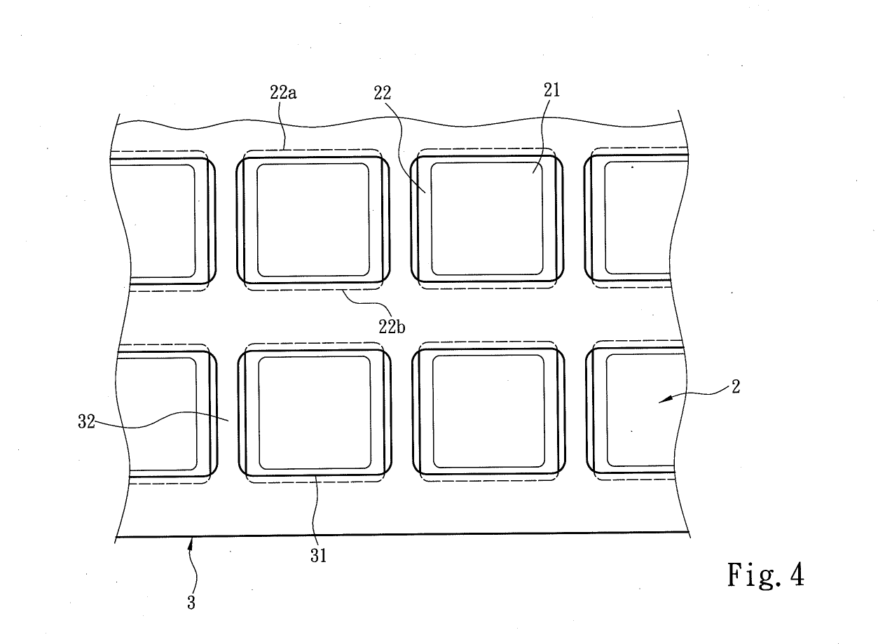

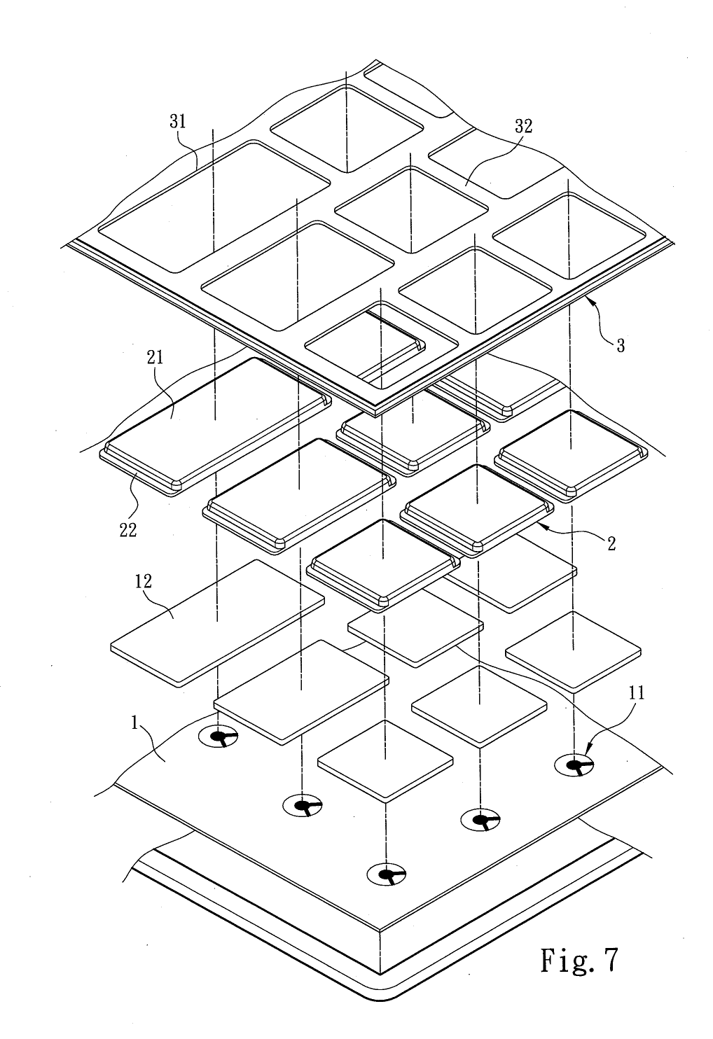

The aforesaid embodiment has all the end portions of the holding surface 22 overlapped with the ribs 32 to confine positioning of the keycap 2. But this is not the limitation of the invention. The installation portion 31 could have a small deformation such that the rib 32 merely leans two end portions 22a and 22b of the keycap 2, as shown in FIG. 4. The two end portions 22a and 22b also are overlapped with the ribs 32, hence also can confine positioning of the keycap 2. FIG. 4 only depicts an example, but not a limitation of the invention. The embodiment previously discussed has the holding surface 22 extended beyond the circumference of the press surface 21 so that the end portions of the press surface 21 are overlapped with the ribs 32. But this also is not the limitation of the invention. The holding surface 22 can also be extended beyond two sides of the press surface 21 as shown in FIG. 7. The ribs 32 are overlapped with the holding surface 22 extended from two sides of the press surface 21.

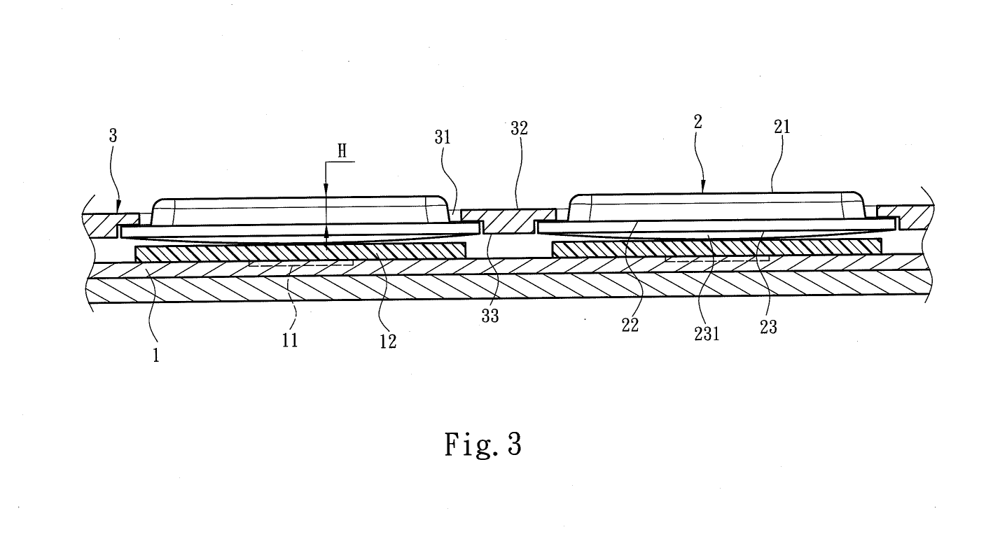

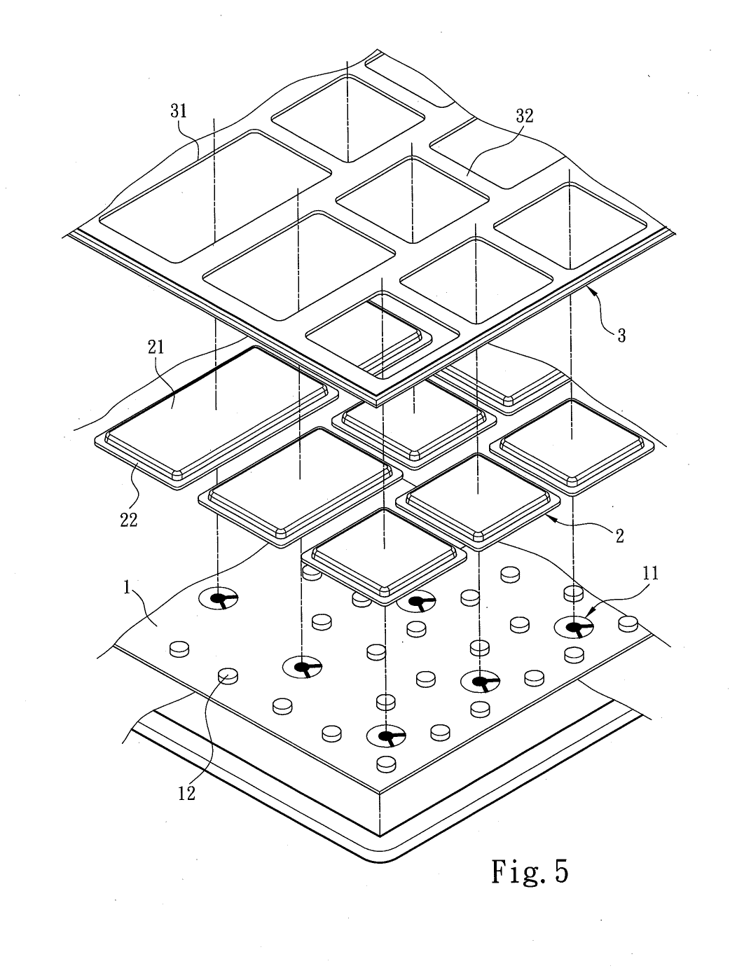

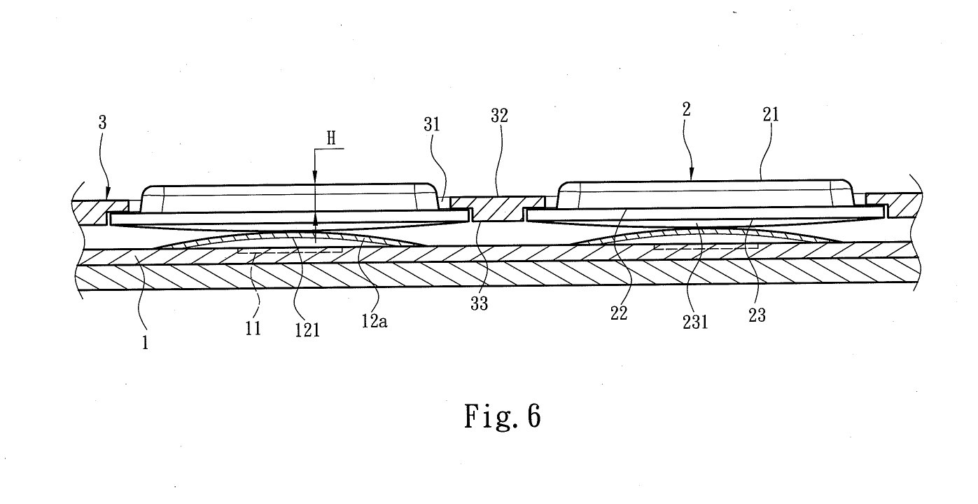

In addition, after assembly of the elastic support member 12 and keycap 2 is finished, the elastic support member 12 can be located in the center of the keycap 2, or at four corners of the keycap 2 as shown in FIG. 5. The elastic support member 12 can be a sponge. Referring to FIG. 6, the elastic support member 12a can further include a trigger portion 121 to connect the circuit board 1 to generate a command signal when the keycap 2 is depressed. The elastic support member 12a equipped with the trigger portion 121 can be a flexible dome. Referring to FIGS. 3 and 6, the keycap 2 can further have a bottom surface 23 opposite to the press surface 21 and holding surface 22, and facing the circuit board 1. The bottom surface 23 further has a contact portion 231 extended towards the circuit board 1 to connect the command portion 11 when the keycap 2 is depressed to generate the command signal.

As a conclusion, the thin keyboard of the invention employs a novel implementation approach without the conventional driven mechanisms, hence the keyboard can be made thinner. With the frame confining the positioning and movement of the keycaps, assembly and installation can be accomplished via simple alignment. As a result, the thin keyboard of the invention can be made thinner than the conventional keyboards, and also has other advantages, such as easier assembly and installation, and simplified structure.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A thin keyboard, comprising:
a circuit board including a plurality of command portions to receive contact to generate command signals and a plurality of elastic support members located on the command portions;
a plurality of keycaps positioned corresponding to the elastic support members, each keycap including at least one depressible press surface and a holding surface opposed the press surface and formed at an elevation difference interval with the press surface, the transverse cross section of the holding surface greater than the transverse cross section of the press surface; and
a frame corresponding to the keycaps and including a plurality of installation portions corresponding to the keycaps, and a plurality of ribs abutting the circumference of the installation portions and overlapped over the holding surface of each keycap, each installation portion having a carved out area which is smaller than the holding surface;
whereby the installation portions and the ribs confine positioning and movement of the keycaps.

2. The thin keyboard of claim 1, wherein the frame is formed at a thickness smaller than the elevation difference interval of the press surface and the holding surface.

3. The thin keyboard of claim 1, wherein the frame is formed at a thickness same as the elevation difference interval of the press surface and the holding surface.

4. The thin keyboard of claim 1, wherein the holding surface is extended beyond two sides of the press surface.

5. The thin keyboard of claim 1, wherein the rib is overlapped over two end portions of the press surface.

6. The thin keyboard of claim 1, wherein the frame includes a retaining portion on the location where the rib overlaps over the holding surface.

7. The thin keyboard of claim 1, wherein the elastic support members are located in the center of the keycaps.

8. The thin keyboard of claim 1, wherein the elastic support members are located at four corners of the keycaps.

9. The thin keyboard of claim 1, wherein each elastic support member includes a trigger portion to connect the circuit board to generate the command signals.

10. The thin keyboard of claim 1, wherein each elastic support member is a flexible dome.

11. The thin keyboard of claim 1, wherein each keycap includes a bottom surface opposite to the press surface and the holding surface and facing the circuit board, the bottom surface including a contact portion extended towards the circuit board.
